(19) United States
(12) Patent Application Publication
(10) Pub. No.: US 2010/0189070 A1
(43) Pub. Date: Jul. 29, 2010

(54) METHODS AND SYSTEMS FOR COMBINING SERVICE FLOW ADDITION/CHANGE WITH HANDOVER IN WIMAX SYSTEMS

(75) Inventors: Guangming Carl Shi, San Diego, CA (US); Fangqi Hu, San Diego, CA (US); Isaac Ta-yan Siu, San Diego, CA (US); Wei Zhang, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/360,847

(22) Filed: Jan. 27, 2009

(51) Int. Cl. H04W 36/00

(52) U.S. Cl. 370/331

(57) ABSTRACT

The present disclosure proposes a method for incorporating a procedure of adding/changing a service flow of a mobile station into a handover process in order to avoid problem that the mobile station can handover to a neighbor base station that do not support the requested service flow operation. Furthermore, the proposed disclosure can reduce the processing delay by combining the handover process of the mobile station and the procedure of adding/changing the service flow.

### TECHNICAL FIELD

Certain embodiments of the present disclosure generally relate to wireless communications and, more particularly, to a method to incorporate addition or change of a service flow into a handover process.

### SUMMARY

Certain embodiments provide a method for performing a handover of a mobile station in a wireless communication system. The method generally includes sending, to a serving base station, a mobile handover request message specifying a change to a service flow, the change comprising at least one of: an addition of a service flow, a deletion of a service flow, and a modification of an existing service flow, receiving, in response to the request message, a list of neighbor base stations with resources suitable for supporting the change to the service flow, selecting a target base station from the received list of neighbor base stations, and performing operations to handover to the selected target base station.

Certain embodiments provide a method for operating at a serving base station during a handover in a wireless communication system. The method generally includes broadcasting a request with a compound service flow request type-length-value (TLV) to neighbor base stations to request the neighbor base stations check their available resources, and transferring, to a selected target base station for the handover, a current context of a mobile station including a change to a service flow, the change comprising at least one of: an addition of a service flow, a deletion of a service flow, and a modification of an existing service flow.

Certain embodiments provide a method for operating at a target base station during a handover to that base station in a wireless communication system. The method generally includes storing a current context of a mobile station including a requested change to a service flow, the change comprising at least one of: an addition of a service flow, a deletion of a service flow, and a modification of an existing service flow, and sending a response message to confirm the requested change.

Certain embodiments provide an apparatus for performing a handover of a mobile station in a wireless communication system. The apparatus generally includes logic for sending, to a serving base station, a mobile handover request message specifying a change to a service flow, the change comprising at least one of: an addition of a service flow, a deletion of a service flow, and a modification of an existing service flow, logic for receiving, in response to the request message, a list of neighbor base stations with resources suitable for supporting the change to the service flow, logic for selecting a target base station from the received list of neighbor base stations, and logic for performing operations to handover to the selected target base station.

Certain embodiments provide an apparatus for operating at a serving base station during a handover in a wireless communication system. The apparatus generally includes logic for broadcasting a request with a compound service flow request type-length-value (TLV) to neighbor base stations to request the neighbor base stations check their available resources, and logic for transferring, to a selected target base station for the handover, a current context of a mobile station including a change to a service flow, the change comprising at least one of: an addition of a service flow, a deletion of a service flow, and a modification of an existing service flow.

Certain embodiments provide an apparatus for operating at a target base station during a handover to that base station in a wireless communication system. The apparatus generally includes logic for storing a current context of a mobile station including a requested change to a service flow, the change comprising at least one of: an addition of a service flow, a deletion of a service flow, and a modification of an existing service flow, and logic for sending a response message to confirm the requested change.

Certain embodiments provide an apparatus for performing a handover of a mobile station in a wireless communication system. The apparatus generally includes means for sending, to a serving base station, a mobile handover request message specifying a change to a service flow, the change comprising at least one of: an addition of a service flow, a deletion of a service flow, and a modification of an existing service flow, means for receiving, in response to the request message, a list of neighbor base stations with resources suitable for supporting the change to the service flow, means for selecting a target base station from the received list of neighbor base stations, and means for performing operations to handover to the selected target base station.

Certain embodiments provide an apparatus for operating at a serving base station during a handover in a wireless communication system. The apparatus generally includes means for broadcasting a request with a compound service flow request type-length-value (TLV) to neighbor base stations to request the neighbor base stations check their available resources, and means for transferring, to a selected target base station for the handover, a current context of a mobile station including a change to a service flow, the change comprising at least one of: an addition of a service flow, a deletion of a service flow, and a modification of an existing service flow.

Certain embodiments provide an apparatus for operating at a target base station during a handover to that base station in a wireless communication system. The apparatus generally includes means for storing a current context of a mobile station including a requested change to a service flow, the change comprising at least one of: an addition of a service flow, a deletion of a service flow, and a modification of an existing service flow, and means for sending a response message to confirm the requested change.

Certain embodiments provide a computer-program product for performing a handover of a mobile station in a wireless communication system, comprising a computer readable medium having instructions stored thereon, the instructions being executable by one or more processors. The instructions generally include instructions for sending, to a serving base station, a mobile handover request message specifying a change to a service flow, the change comprising at least one of: an addition of a service flow, a deletion of a service flow, and a modification of an existing service flow, instructions for receiving, in response to the request message, a list of neighbor base stations with resources suitable for supporting the change to the service flow, instructions for selecting a target base station from the received list of neighbor base stations, and instructions for performing operations to handover to the selected target base station.

Certain embodiments provide a computer-program product for operating at a serving base station during a handover in a wireless communication system, comprising a computer readable medium having instructions stored thereon, the instructions being executable by one or more processors. The instructions generally include instructions for broadcasting a request with a compound service flow request type-length-value (TLV) to neighbor base stations to request the neighbor base stations check their available resources, and instructions for transferring, to a selected target base station for the handover, a current context of a mobile station including a change to a service flow, the change comprising at least one of: an addition of a service flow, a deletion of a service flow, and a modification of an existing service flow.

Certain embodiments provide a computer-program product for operating at a target base station during a handover to that base station in a wireless communication system, comprising a computer readable medium having instructions stored thereon, the instructions being executable by one or more processors. The instructions generally include instructions for storing a current context of a mobile station including a requested change to a service flow, the change comprising at least one of: an addition of a service flow, a deletion of a service flow, and a modification of an existing service flow, and instructions for sending a response message to confirm the requested change.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system in accordance with certain embodiments of the present disclosure.

FIG. 4 shows a process flow diagram of a method to combine addition/change of a service flow with a handover in accordance with certain embodiments of the present disclosure.

FIG. 4A illustrates example components capable of performing the operations illustrated in FIG. 4.

FIG. 5 illustrates a signaling between communication entities of the wireless system for the purpose of combining addition/change of the service flow with the handover in accordance with certain embodiments of the present disclosure.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

A handover process can be triggered by an overload control condition that does not allow a mobile station (MS) to add a new service flow or to change the existing service flow that requires additional resources. If a serving base station (BS) cannot support a newly requested or modified service flow, then the MS should handover to some neighbor BS with appropriate signal strength and sufficient resources.

However, current handover messages defined for Worldwide Interoperability for Microwave Access (WiMAX) standards do not allow the MS to add or change the service flow during the handover process. The MS needs to first successfully complete the handover to a newly serving BS and then to add or change the service flow. This approach may create a certain risk that the MS can handover to a neighbor BS that cannot support the addition or change in the service flow.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One specific example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

IEEE 802.16x is an emerging standard organization to define an air interface for fixed and mobile broadband wireless access (BWA) systems. These standards define at least four different physical layers (PHYs) and one medium access control (MAC) layer. The OFDM and OFDMA physical layer of the four physical layers are the most popular in the fixed and mobile BWA areas respectively.

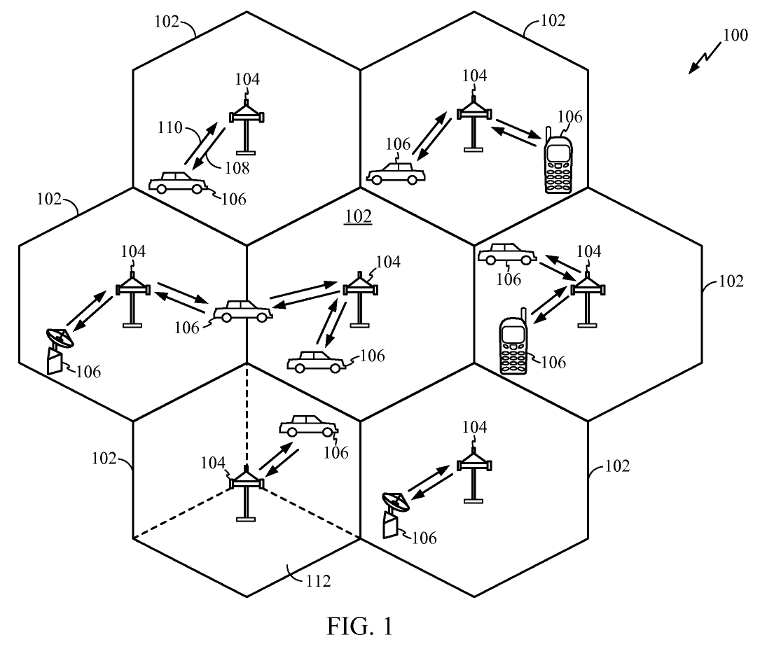

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink (DL) 108, and a communication link that facilitates transmission from a user terminal 106 to a base station 104 may be referred to as an uplink (UL) 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

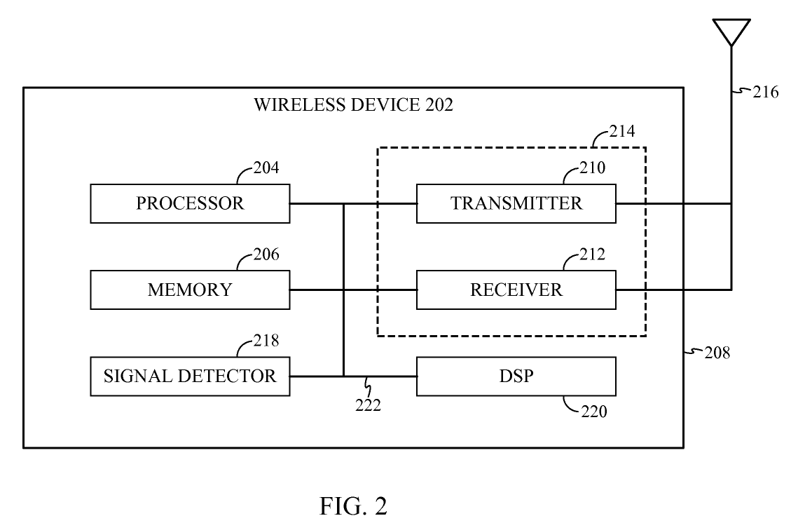

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

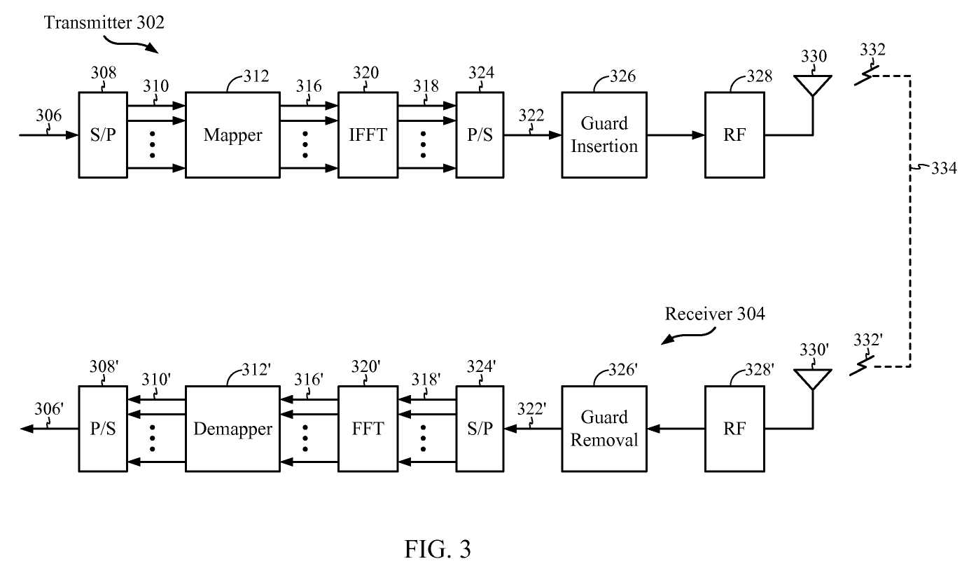

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into M parallel data streams 310.

The M parallel data streams 310 may then be provided as input to a mapper 312. The mapper 312 may map the M parallel data streams 310 onto M constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output M parallel symbol streams 316, each symbol stream 316 corresponding to one of the M orthogonal subcarriers of the inverse fast Fourier transform (IFFT) 320. These M parallel symbol streams 316 are represented in the frequency domain and may be converted into M parallel time domain sample streams 318 by an IFFT component 320.

A brief note about terminology will now be provided. M parallel modulations in the frequency domain are equal to M modulation symbols in the frequency domain, which are equal to M mapping and M-point IFFT in the frequency domain, which is equal to one (useful) OFDM symbol in the time domain, which is equal to M samples in the time domain. One OFDM symbol in the time domain, Ns, is equal to Ncp (the number of guard samples per OFDM symbol)+M (the number of useful samples per OFDM symbol).

The M parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the M parallel time-domain symbol streams 318′, each of which corresponds to one of the M orthogonal subcarriers. A fast Fourier transform (FFT) component 320′ may convert the M parallel time-domain symbol streams 318′ into the frequency domain and output M parallel frequency-domain symbol streams 316′.

A demapper 312′ may perform the inverse of the symbol mapping operation that was performed by the mapper 312 thereby outputting M parallel data streams 310′. A P/S converter 308′ may combine the M parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found in a baseband processor 340′.

Combining Addition/Change of Service Flow with Handover

According to certain embodiments, when a serving base station (BS) does not have enough resources to support a newly requested or modified service flow of a mobile station (MS), then the MS may handover to some neighbor BS with an appropriate signal strength and sufficient resources. However, current handover controlling messages specified for WiMAX systems do not allow the MS to add or change the service flow before the handover process is successfully finished.

Therefore, the MS may need to first complete the handover to a target BS and then to add or change the service flow. Therefore, there is a certain risk that the MS can handover to a BS that is not able to support newly requested service flow or requested service flow change.

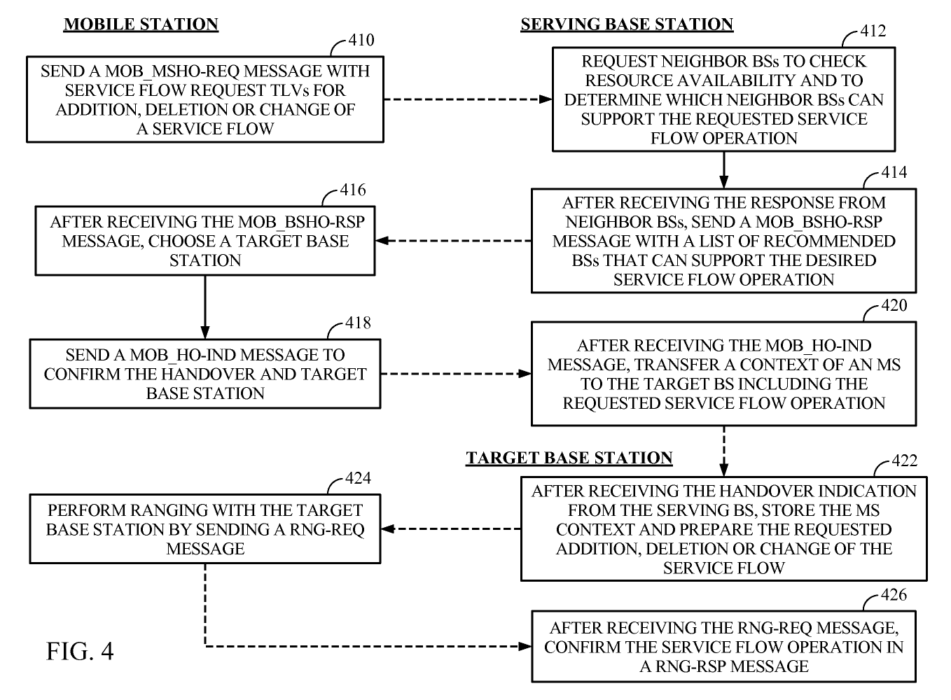

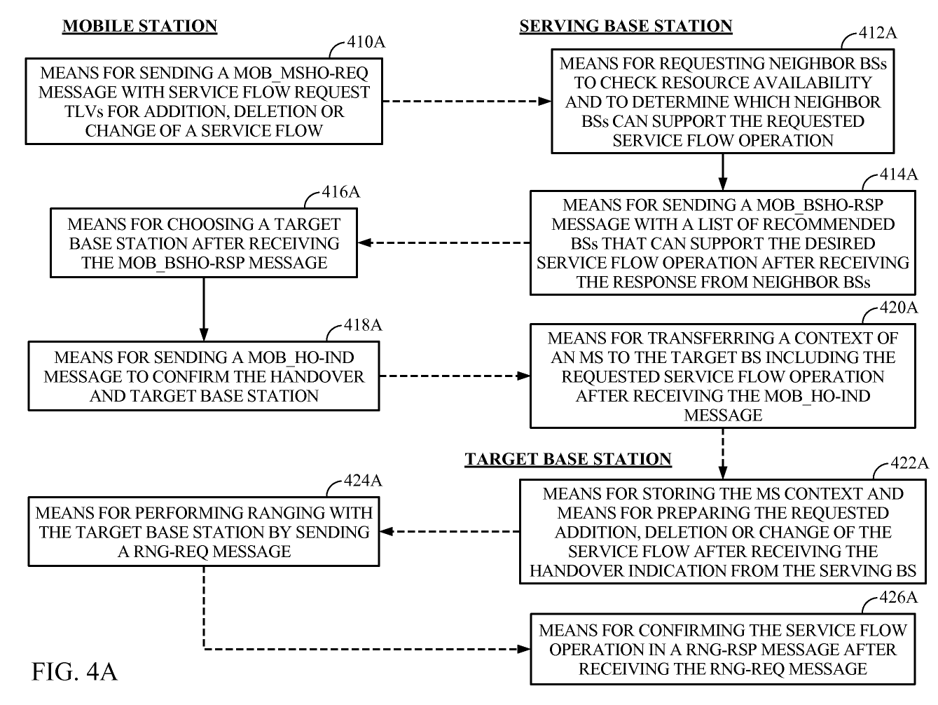

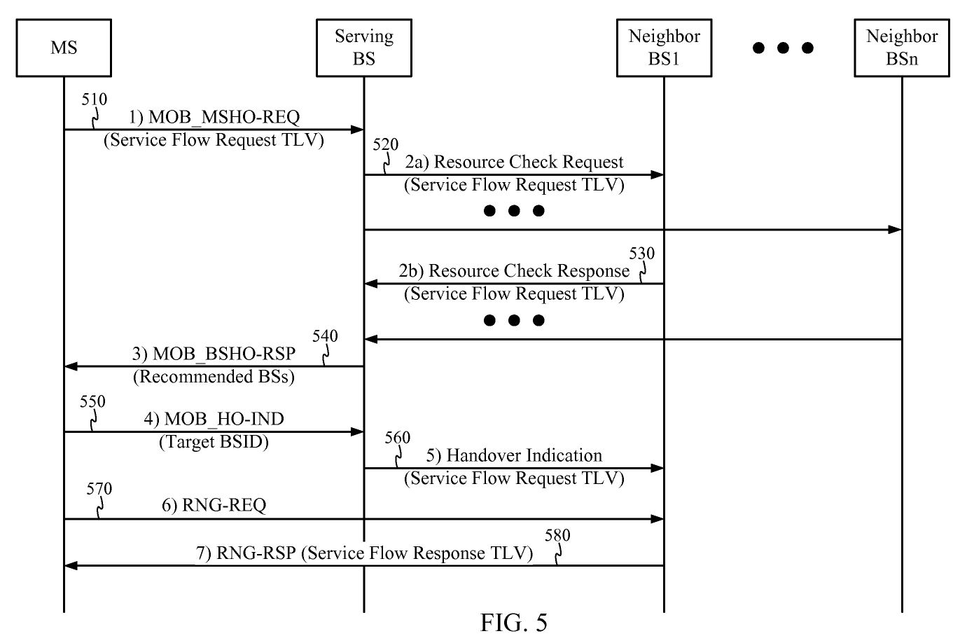

Certain embodiments of the present disclosure, however, provide a technique to incorporate a change to the service flow (e.g., addition, deletion, or modification a service flow) into the handover process. FIG. 4 illustrates example operations 400 for combining an addition/change of the service flow with the handover. FIG. 5 illustrates an exchange of control messages between communication entities of the wireless system for the purpose of combining addition/change of the service flow with the handover process corresponding to the example operations 400.

The operations 400 begin, at 410, with the MS sending to a serving BS a Mobile MS Handover Request (MOB_MSHO-REQ) message 510. As illustrated in FIG. 5, the message 510 may include a service flow request Type-Length-Value (TLV) that specifies an addition, deletion or change of the service flow. If the MOB_MSHO-REQ message refers to the addition of the service flow, then a whole set of service flow parameters may be specified in the MOB_MSHO-REQ message. If the MOB_MSHO-REQ message refers to a deletion of the service flow, then only the existing Connection Identifier (CID) may be specified. If the MOB_MSHO-REQ message refers to a change of the service flow, then the existing CID and service flow parameters that are being changed may be specified.

Table 1 shows a structure of the MOB_MSHO-REQ message with a proposed service flow request TLV according to certain embodiments. The service flow request TLV is a compound TLV, and its detailed structure is shown in Table 2.

TABLE 1
Example Structure of the MOB_MSHO-REQ message

| Field | Size | Description | Comments |
|---|---|---|---|
| Management | 8 bits | Management Message | Existing |
| Message Type | | Type = 57 | Field |
| Report Metric | 7 bits | Report Metric | Existing |
| | | | Field |
| . . . | . . . | . . . | . . . |
| . . . | . . . | . . . | . . . |
| Service Flow | Variable | Service Flow | New TLV is |
| Request | | Request TLV | proposed. |
| CMAC Tuple | 13 or 19 | CMAC Tuple TLV | Existing TLV |
| | bytes | | (Type = 141) |

TABLE 2
Example Structure of the service flow request TLV

| TLV Name | Size | Description | Comments |
|---|---|---|---|
| Operation | 1 byte | 0: Service Flow Addition | New TLV is |
| | | 1: Service Flow Change | proposed |
| | | 2: Service Flow Deletion | |
| Downlink | Variable | DL service flow parameters | Existing TLV |
| Service Flow | | | (Type = 146) |
| Uplink Service | Variable | UL service flow parameters | Existing TLV |
| Flow | | | (Type = 145) |

The downlink (DL) service flow and the uplink (UL) service flow TLVs are defined for existing WiMAX standards and they are also compound TLVs. The DL and UL service flow TLVs may define detailed service flow parameters that may be added or changed. On the other hand, if the MOB_MSHO-REQ message refers to the deletion of the service flow, then the operation TLV may have a value of “2” representing “service flow deletion,” as shown in Table 2. In this case, the DL service flow or the UL service flow may only include the CID TLV. Table 3 shows a structure of the compound DL/UL service flow TLV as specified for the IEEE 802.16 standard.

TABLE 3
Structure of the DL/UL service flow TLV in the IEEE 802.16 standard

| | TLV | | |
|---|---|---|---|
| TLV Name | Type | Description | Comments |
| SFID | 1 | Service Flow ID | Existing TLV |
| CID | 2 | Connection ID | Existing TLV |
| Service Class Name | 3 | Service Class Name | Existing TLV |
| MBS | 4 | Multicast Broadcast | Existing TLV |
| | | Service | |
| QoS Parameter Set Type | 5 | | Existing TLV |
| Traffic Priority | 6 | | Existing TLV |
| Maximum Sustained | 7 | | Existing TLV |
| Traffic Rate | | | |
| Maximum Traffic Burst | 8 | | Existing TLV |
| Maximum Reserved | 9 | | Existing TLV |
| Traffic Rate | | | |
| . . . | . . . | . . . | . . . |
| Vendor-Specific QoS | 143 | | Existing TLV |
| Parameter | | | |

At 412, after receiving the MOB_MSHO-REQ message, the serving BS may request from neighbor base stations to check their resource availability for determining which neighbor base stations can support desired service flow operation. As illustrated in FIG. 5, resource check request messages 520 with compound service flow request TLVs may be broadcasted to all neighbor base stations. Because the resource availability of neighbor base stations is checked before starting the handover, there is a higher probability that the MS may handover to a neighbor BS with available resources for supporting the desired service flow operation.

At 414, after receiving the resource check response messages 530 from neighbor base stations, the serving BS may send a Mobile Base Station Handover Response (MOB_BSHO-RSP) message 540 to the MS with a list of recommended base stations for handover, which can also support the desired service flow operation. At 416, after receiving the MOB_BSHO-RSP message, the MS may choose a target BS for the handover from the list of recommended base stations. At 418, the MS may send to the serving BS a Mobile Handover Indication (MOB_HO-IND) message 550 with an identification (ID) of the selected target BS for confirming the handover to the specified target BS.

At 420, once the MOB_HO-IND message is received, the serving BS may transfer a current context of the MS (including the requested addition/change of the service flow) to the selected target BS by sending a handover indication message 560 to the target BS. At 422, after receiving the handover indication message, the target BS may store the current MS context and prepare requested addition, deletion or change of the service flow.

At 424, the MS may perform a ranging with the target BS by sending a Range Request (RNG-REQ) message 570 to the selected target BS. At 426, after receiving the RNG-REQ message, the target BS may confirm the service flow operation within a Range Response (RNG-RSP) message 580. The RNG-RSP message may include a service flow response TLV that indicates a status of the requested service flow operation, and some service flow parameters, such as a Service Flow Identifier (SFID) and a Connection Identifier (CID). An example structure of the RNG-RSP message with the proposed service flow response TLV is shown in Table 4.

TABLE 4
Example Structure of the RNG-RSP message

| Field | Size | | Description | Comments |
|---|---|---|---|---|
| Management | 8 | bits | Management Message | Existing |
| Message Type | | | Type = 5 | Field |
| Reserved | 8 | bits | | Existing |
| | | | | Field |
| Timing | 4 | bytes | . . . | Existing TLV |
| Adjustment | | | | (Type = 1) |
| Power Level | 1 | byte | . . . | Existing TLV |
| Adjustment | | | | (Type = 2) |
| . . . | . . . | | . . . | . . . |
| Service Flow | variable | | Service Flow | New TLV is |
| Response | | | Response TLV | proposed. |
| CMAC Tuple | 13 or 19 | bytes | CMAC Tuple TLV | Existing TLV |
| | | | | (Type = 141) |

The proposed service flow response TLV is a compound TLV with a structure given in Table 5. The DL/UL service flow TLVs may define detailed service flow parameters if the target BS intends to modify service flow parameters in a different way compared to what is proposed by the MS. If the target BS fully accepts the service flow request, then the DL/UL service flow TLVs may only include the SFID and the CID. If the target BS fully rejects the service flow request, then only the response status TLV may be included. If the target BS partially accepts the service flow request, then only DL/UL service flow TLVs that are being accepted are included in the compound service flow response TLV.

TABLE 5
Structure of the Service Flow Response TLV

| TLV Name | Size | Description | Comments |
|---|---|---|---|
| Response Status | 1 byte | 0: Accept | New TLV is |
| | | 1: Reject | proposed. |
| | | 2: Modification | |
| Downlink Service Flow | variable | DL service flow | Existing TLV |
| | | parameters | (Type = 146) |
| Uplink Service Flow | variable | UL service flow | Existing TLV |
| | | parameters | (Type = 145) |

The various operations of methods described above may be performed by various hardware and/or software component(s) and/or module(s) corresponding to means-plus-function blocks illustrated in the Figures. For example, blocks 410-426 illustrated in FIG. 4 correspond to means-plus-function blocks 410A-426A illustrated in FIG. 4A. More generally, where there are methods illustrated in Figures having corresponding counterpart means-plus-function Figures, the operation blocks correspond to means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for performing a handover of a mobile station in a wireless communication system, comprising:
sending, to a serving base station, a mobile handover request message specifying a change to a service flow, the change comprising at least one of: an addition of a service flow, a deletion of a service flow, and a modification of an existing service flow;
receiving, in response to the request message, a list of neighbor base stations with resources suitable for supporting the change to the service flow;
selecting a target base station from the received list of neighbor base stations; and
performing operations to handover to the selected target base station.

2. The method of claim 1, wherein the mobile handover request message comprises a compound service flow request type-length-value (TLV).

3. The method of claim 1 further comprising:
sending, to the serving base station, a mobile handover indication message to confirm the handover to the selected target base station; and
performing a ranging process with the selected target base station.

4. The method of claim 2, wherein the compound service flow request TLV comprises an operation TLV that specifies the change.

5. The method of claim 4, wherein a complete set of service flow parameters is included in the compound service flow request TLV, if the operation TLV specifies addition of the service flow.

6. The method of claim 4, wherein an existing connection identifier is included in the compound service flow request TLV, if the operation TLV specifies deletion of the service flow.

7. The method of claim 4, wherein an existing connection identifier and one or more service flow parameters being changed are included in the compound service flow request TLV, if the operation TLV specifies modification of the existing service flow.

8. A method for operating at a serving base station during a handover in a wireless communication system, comprising:
broadcasting a request with a compound service flow request type-length-value (TLV) to neighbor base stations to request the neighbor base stations check their available resources; and
transferring, to a selected target base station for the handover, a current context of a mobile station including a change to a service flow, the change comprising at least one of: an addition of a service flow, a deletion of a service flow, and a modification of an existing service flow.

9. The method of claim 8 further comprising:
determining a list of neighbor base stations that can support the requested change.

10. The method of claim 8, wherein the compound service flow request TLV comprises an operation TLV that specifies the change.

11. The method of claim 10, wherein an existing connection identifier and one or more service flow parameters being changed are included in the compound service flow request TLV, if the operation TLV specifies modification of the existing service flow.

12. A method for operating at a target base station during a handover to that base station in a wireless communication system, comprising:
storing a current context of a mobile station including a requested change to a service flow, the change comprising at least one of: an addition of a service flow, a deletion of a service flow, and a modification of an existing service flow; and
sending a response message to confirm the requested change.

13. The method of claim 12, wherein the range response message comprises a compound service flow response type-length-value (TLV).

14. The method of claim 13, wherein the compound service flow response TLV comprises a response status TLV that specifies that the requested change is fully accepted, partially accepted or rejected.

15. The method of claim 14, wherein a service flow identifier and an existing connection identifier are included in the compound service flow response TLV, if the requested change is fully accepted.

16. The method of claim 14, wherein detailed service flow parameters are included in the compound service flow TLV, if the target base station intends to modify service flow parameters in a different way from what is proposed by the mobile station.

17. An apparatus for performing a handover of a mobile station in a wireless communication system, comprising:
logic for sending, to a serving base station, a mobile handover request message specifying a change to a service flow, the change comprising at least one of: an addition of a service flow, a deletion of a service flow, and a modification of an existing service flow;
logic for receiving, in response to the request message, a list of neighbor base stations with resources suitable for supporting the change to the service flow;
logic for selecting a target base station from the received list of neighbor base stations; and
logic for performing operations to handover to the selected target base station.

18. The apparatus of claim 17, wherein the mobile handover request message comprises a compound service flow request type-length-value (TLV).

19. The apparatus of claim 17 further comprising:
logic for sending, to the serving base station, a mobile handover indication message to confirm the handover to the selected target base station; and
logic for performing a ranging process with the selected target base station.

20. The apparatus of claim 18, wherein the compound service flow request TLV comprises an operation TLV that specifies the change.

21. The apparatus of claim 20, wherein a complete set of service flow parameters is included in the compound service flow request TLV, if the operation TLV specifies addition of the service flow.

22. The apparatus of claim 20, wherein an existing connection identifier is included in the compound service flow request TLV, if the operation TLV specifies deletion of the service flow.

23. The apparatus of claim 20, wherein an existing connection identifier and one or more service flow parameters being changed are included in the compound service flow request TLV, if the operation TLV specifies modification of the existing service flow.

24. An apparatus for operating at a serving base station during a handover in a wireless communication system, comprising:
logic for broadcasting a request with a compound service flow request type-length-value (TLV) to neighbor base stations to request the neighbor base stations check their available resources; and
logic for transferring, to a selected target base station for the handover, a current context of a mobile station including a change to a service flow, the change comprising at least one of: an addition of a service flow, a deletion of a service flow, and a modification of an existing service flow.

25. The apparatus of claim 24 further comprising:
logic for determining a list of neighbor base stations that can support the requested change.

26. The apparatus of claim 24, wherein the compound service flow request TLV comprises an operation TLV that specifies the change.

27. The apparatus of claim 26, wherein an existing connection identifier and one or more service flow parameters being changed are included in the compound service flow request TLV, if the operation TLV specifies modification of the existing service flow.

28. An apparatus for operating at a target base station during a handover to that base station in a wireless communication system, comprising:
logic for storing a current context of a mobile station including a requested change to a service flow, the change comprising at least one of: an addition of a service flow, a deletion of a service flow, and a modification of an existing service flow; and
logic for sending a response message to confirm the requested change.

29. The apparatus of claim 28, wherein the range response message comprises a compound service flow response type-length-value (TLV).

30. The apparatus of claim 29, wherein the compound service flow response TLV comprises a response status TLV that specifies that the requested change is fully accepted, partially accepted or rejected.

31. The apparatus of claim 30, wherein a service flow identifier and an existing connection identifier are included in the compound service flow response TLV, if the requested change is fully accepted.

32. The apparatus of claim 30, wherein detailed service flow parameters are included in the compound service flow TLV, if the target base station intends to modify service flow parameters in a different way from what is proposed by the mobile station.

33. An apparatus for performing a handover of a mobile station in a wireless communication system, comprising:
means for sending, to a serving base station, a mobile handover request message specifying a change to a service flow, the change comprising at least one of: an addition of a service flow, a deletion of a service flow, and a modification of an existing service flow;
means for receiving, in response to the request message, a list of neighbor base stations with resources suitable for supporting the change to the service flow;
means for selecting a target base station from the received list of neighbor base stations; and
means for performing operations to handover to the selected target base station.

34. The apparatus of claim 33, wherein the mobile handover request message comprises a compound service flow request type-length-value (TLV).

35. The apparatus of claim 33 further comprising:
means for sending, to the serving base station, a mobile handover indication message to confirm the handover to the selected target base station; and
means for performing a ranging process with the selected target base station.

36. The apparatus of claim 34, wherein the compound service flow request TLV comprises an operation TLV that specifies the change.

37. The apparatus of claim 36, wherein a complete set of service flow parameters is included in the compound service flow request TLV, if the operation TLV specifies addition of the service flow.

38. The apparatus of claim 36, wherein an existing connection identifier is included in the compound service flow request TLV, if the operation TLV specifies deletion of the service flow.

39. The apparatus of claim 36, wherein an existing connection identifier and one or more service flow parameters being changed are included in the compound service flow request TLV, if the operation TLV specifies modification of the existing service flow.

40. An apparatus for operating at a serving base station during a handover in a wireless communication system, comprising:
means for broadcasting a request with a compound service flow request type-length-value (TLV) to neighbor base stations to request the neighbor base stations check their available resources; and
means for transferring, to a selected target base station for the handover, a current context of a mobile station including a change to a service flow, the change comprising at least one of: an addition of a service flow, a deletion of a service flow, and a modification of an existing service flow.

41. The apparatus of claim 40 further comprising:
means for determining a list of neighbor base stations that can support the requested change.

42. The apparatus of claim 40, wherein the compound service flow request TLV comprises an operation TLV that specifies the change.

43. The apparatus of claim 42, wherein an existing connection identifier and one or more service flow parameters being changed are included in the compound service flow request TLV, if the operation TLV specifies modification of the existing service flow.

44. An apparatus for operating at a target base station during a handover to that base station in a wireless communication system, comprising:
means for storing a current context of a mobile station including a requested change to a service flow, the change comprising at least one of: an addition of a service flow, a deletion of a service flow, and a modification of an existing service flow; and
means for sending a response message to confirm the requested change.

45. The apparatus of claim 44, wherein the range response message comprises a compound service flow response type-length-value (TLV).

46. The apparatus of claim 45, wherein the compound service flow response TLV comprises a response status TLV that specifies that the requested change is fully accepted, partially accepted or rejected.

47. The apparatus of claim 46, wherein a service flow identifier and an existing connection identifier are included in the compound service flow response TLV, if the requested change is fully accepted.

48. The apparatus of claim 46, wherein detailed service flow parameters are included in the compound service flow TLV, if the target base station intends to modify service flow parameters in a different way from what is proposed by the mobile station.

49. A computer-program product for performing a handover of a mobile station in a wireless communication system, comprising a computer readable medium having instructions stored thereon, the instructions being executable by one or more processors and the instructions comprising:
instructions for sending, to a serving base station, a mobile handover request message specifying a change to a service flow, the change comprising at least one of: an addition of a service flow, a deletion of a service flow, and a modification of an existing service flow;
instructions for receiving, in response to the request message, a list of neighbor base stations with resources suitable for supporting the change to the service flow;
instructions for selecting a target base station from the received list of neighbor base stations; and
instructions for performing operations to handover to the selected target base station.

50. The computer-program product of claim 49, wherein the mobile handover request message comprises a compound service flow request type-length-value (TLV).

51. The computer-program product of claim 49, wherein the instructions further comprise:
instructions for sending, to the serving base station, a mobile handover indication message to confirm the handover to the selected target base station; and
instructions for performing a ranging process with the selected target base station.

52. The computer-program product of claim 50, wherein the compound service flow request TLV comprises an operation TLV that specifies the change.

53. The computer-program product of claim 52, wherein a complete set of service flow parameters is included in the compound service flow request TLV, if the operation TLV specifies addition of the service flow.

54. The computer-program product of claim 52, wherein an existing connection identifier is included in the compound service flow request TLV, if the operation TLV specifies deletion of the service flow.

55. The computer-program product of claim 52, wherein an existing connection identifier and one or more service flow parameters being changed are included in the compound service flow request TLV, if the operation TLV specifies modification of the existing service flow.

56. A computer-program product for operating at a serving base station during a handover in a wireless communication system, comprising a computer readable medium having instructions stored thereon, the instructions being executable by one or more processors and the instructions comprising:
instructions for broadcasting a request with a compound service flow request type-length-value (TLV) to neighbor base stations to request the neighbor base stations check their available resources; and
instructions for transferring, to a selected target base station for the handover, a current context of a mobile station including a change to a service flow, the change comprising at least one of: an addition of a service flow, a deletion of a service flow, and a modification of an existing service flow.

57. The computer-program product of claim 56, wherein the instructions further comprise:
instructions for determining a list of neighbor base stations that can support the requested change.

58. The computer-program product of claim 56, wherein the compound service flow request TLV comprises an operation TLV that specifies the change.

59. The computer-program product of claim 58, wherein an existing connection identifier and one or more service flow parameters being changed are included in the compound service flow request TLV, if the operation TLV specifies modification of the existing service flow.

60. A computer-program product for operating at a target base station during a handover to that base station in a wireless communication system, comprising a computer readable medium having instructions stored thereon, the instructions being executable by one or more processors and the instructions comprising:
instructions for storing a current context of a mobile station including a requested change to a service flow, the change comprising at least one of: an addition of a service flow, a deletion of a service flow, and a modification of an existing service flow; and
instructions for sending a response message to confirm the requested change.

61. The computer-program product of claim 60, wherein the range response message comprises a compound service flow response type-length-value (TLV).

62. The computer-program product of claim 61, wherein the compound service flow response TLV comprises a response status TLV that specifies that the requested change is fully accepted, partially accepted or rejected.

63. The computer-program product of claim 62, wherein a service flow identifier and an existing connection identifier are included in the compound service flow response TLV, if the requested change is fully accepted.

64. The computer-program product of claim 62, wherein detailed service flow parameters are included in the compound service flow TLV, if the target base station intends to modify service flow parameters in a different way from what is proposed by the mobile station.
